(19) United States
(12) Patent Application Publication
(10) Pub. No.: US 2007/0036622 A1
(43) Pub. Date: Feb. 15, 2007

(54) SPADE DRILL INSERT

(75) Inventor: Young Bae Lee, Kyungkee-Do (KR)

Correspondence Address: VEDDER PRICE KAUFMAN & KAMMHOLZ, 222 N. LASALLE STREET, CHICAGO, IL, 60601, US

(73) Assignee: YG-1 CO., LTD., Incheon (KR)

(21) Appl. No.: 11/161,704

(22) Filed: Aug. 12, 2005

(51) Int. Cl. B23B 51/02

(52) U.S. Cl. 408/227

(57) ABSTRACT

A drill insert includes a pair of cutting webs inclined relative to each other, a pair of transversely opposed cutting portions, each cutting portion partially defining a side portion of a corresponding cutting web. Each cutting portion includes an outer cutting edge, an inner cutting edge connected to the outer cutting edge and having a positive rake angle, and a notch having a first face, a curved second face and a curved valley, the curved valley connecting the first face and the second face. The first face is bound by the curved valley and the inner cutting edge. The drill insert further includes a chisel defined by the first face, the valley, the second face and the inner cutting edge of each cutting portion and the cutting webs converging to a point region.

### FIELD OF THE DISCLOSURE

The present application generally relates to drills, and more particularly, to a spade drill insert.

### BACKGROUND

Drills are typically used to create cylindrical holes in an object. The cutting or boring action of a drill is typically performed by a drill insert rotating about the axis of the bore to be drilled. A mounting side of a drill insert is attached to an insert holder that is connected to a drive system to rotate the insert holder about the longitudinal axis of the holder. The holder can be lowered onto the object to be drilled. Further lowering of the holder onto the object causes the drilling of a bore in the object by the insert. The holder can be lifted out of the bore when a desired bore depth is reached. Alternatively, the object may be moved toward a fixed holder to provide the drilling of the bore.

A problem with some prior art drilling tools is that the point or tip of the insert has a negative rake angle formed by web thinning near the chisel of the insert. This causes the drill insert to inefficiently cut into the object, thereby resulting in deformation of the object. Other prior art drilling tools have a geometry that could result in instability, which can cause deviations in the dimensions of the hole being bored, also known as runout and/or bellmouthing which is undesirable. In addition, some prior art drilling tools have chisel geometry or configuration such that the cut material either does not curl up sufficiently upon being removed from the object, or breaks apart upon being curled up.

Therefore, there exists a need in the art for a drill insert that provides a positive rake angle near the chisel, provides stability when cutting, and is configured to provide efficient curling and/or chipping of the material that is removed from an object during drilling.

### BRIEF DESCRIPTION OF THE DRAWINGS

Certain embodiments are shown in the drawings. However, it is understood that the present disclosure is not limited to the arrangements and instrumentality shown in the attached drawings, wherein:

FIG. 1 illustrates a perspective view of a prior art drill insert;

FIG. 2 illustrates a perspective view of a drill insert constructed in accordance with the teachings of the present disclosure;

FIG. 3 illustrates another perspective view of the drill insert of FIG. 2;

FIG. 4 illustrates a top view of the drill insert of FIG. 2; and

FIG. 5 illustrates a front view of the drill insert of FIG. 2.

### DETAILED DESCRIPTION

For the purposes of promoting and understanding the principles disclosed herein, reference will now be made to the preferred embodiments illustrated in the drawings and specific language will be used to describe the same. It will nevertheless be understood that no limitation of the scope is thereby intended. Such alterations and further modifications in the illustrated device and such further applications are the principles disclosed as illustrated therein as being contemplated as would normally occur to one skilled in the art to which this disclosure relates.

In accordance with one principal aspect of the present disclosure, a drill insert includes a pair of cutting webs inclined relative to each other, and a pair of transversely opposed cutting portions, each cutting portion partially defining a side portion of a corresponding cutting web. Each cutting portion includes an outer cutting edge, an inner cutting edge connected to the outer cutting edge and having a positive rake angle, and

a notch having a first face, a curved second face and a curved valley. The curved valley connects the first face and the second face. The first face is bound by the curved valley and the inner cutting edge. The drill insert further includes a chisel defined by the first face, the valley, the second face and the inner cutting edge of each cutting portion and the cutting webs converging to a point region.

In accordance with another principal aspect of the present disclosure, a chisel portion for a drill insert includes a centrally disposed point region, a pair of inner cutting edges having positive rake angles and transversely opposed to each other relative to the point region, a first notch and a second notch transversely opposed to each other relative to the point region. Each of the first notch and the second notch includes a first face, a curved second face and a curved valley, the curved valley connecting the first face and the second face, and the first face is bound by the curved valley and the corresponding inner cutting edge. The first face, the valley, the second face and the inner cutting edge of each first notch and the second notch converge to the point region.

In accordance with another principal aspect of the present disclosure, a chisel portion for a drill insert includes a centrally disposed point region, a pair of inner cutting edges transversely opposed relative to the point region, and a first notch and a second notch transversely opposed relative to the point region. Each of the first notch and the second notch includes a first face partially defined by the corresponding inner cutting edge and configured to provide a constant positive rake angle for the inner cutting edge, a second face having a curvature configured to provide curling of material cut from an object by the corresponding inner cutting edge, and a valley connecting the first face and the second face, the valley having a curvature configured to control stress concentration at the point region. The first face, the valley, the second face and the inner cutting edge of each first notch and the second notch converge to the point region.

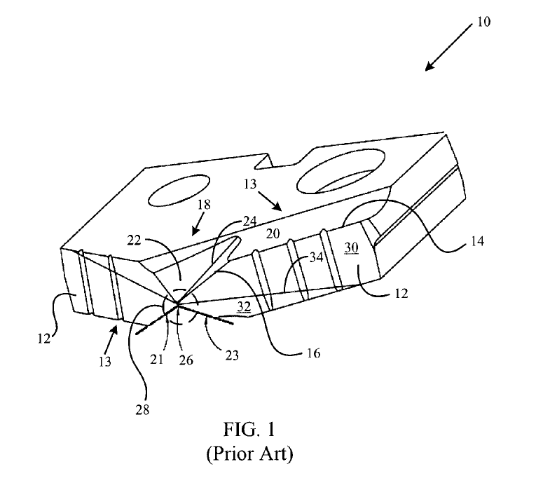

Referring to FIG. 1, a prior art drill insert 10 is shown. The drill insert 10 includes a pair of cutting webs 12 that are inclined relative to each other. A cutting portion 13 of each cutting web 12 includes an outer cutting edge 14 and an inner cutting edge 16. The cutting portions 13 are transversely opposed to each other. Each cutting portion 13 includes a V-notch 18 which has a first face 20 and a second face 22 that meet at a joiner line 24. Each of the first face 20 and the second face 22 is flat, i.e., has no curvature, as represented by lines 21 and 23. The joiner line 24, however, may have a small curvature so that when the inner cutting edge 16 is cutting a material, the cut material can traverse down the first face 20, then through the joiner line 24, and curl up along the second face 22. A chisel 26 of the drill insert 10 is defined by convergence of the cutting web 12 and the V-notch 18 to a point region 28. Each cutting web 12 may include a first web surface 30 and a second web surface 32 that are connected by a web line 34. The first web surface 30 and the second web surface 32 are inclined relative to each other such that the web line 34 defines a peak relative to the first web surface 30 and the second web surface 32. The web surfaces 30 and 32 converge to the point region 28 to form a part of the chisel 26. Accordingly, the chisel 26 is formed by the first web surface 30 and the second web surface 32 of each cutting web 12, and first face 20, the second face 22 and the joinder line 24 of the V-notch 18.

Referring to FIG. 2, a drill insert 37 constructed in accordance with the teachings of the present disclosure is shown. The drill insert 37 is similar in many respects to the prior art drill insert 10. Accordingly, same parts are referred to herein with the same reference numbers. The drill insert 37 includes a notch 38 that has a first face 40 and a curved second face 42 (the first face 40 of the opposing notch 38 is shown in FIG. 1) that are joined by a curved valley 44. When material is cut from an object, the material slides down the first face 40, transitions to the second face 42 along the curved valley 44, and continues to move along the second face 42 while curling by following the curvature of the second face 42.

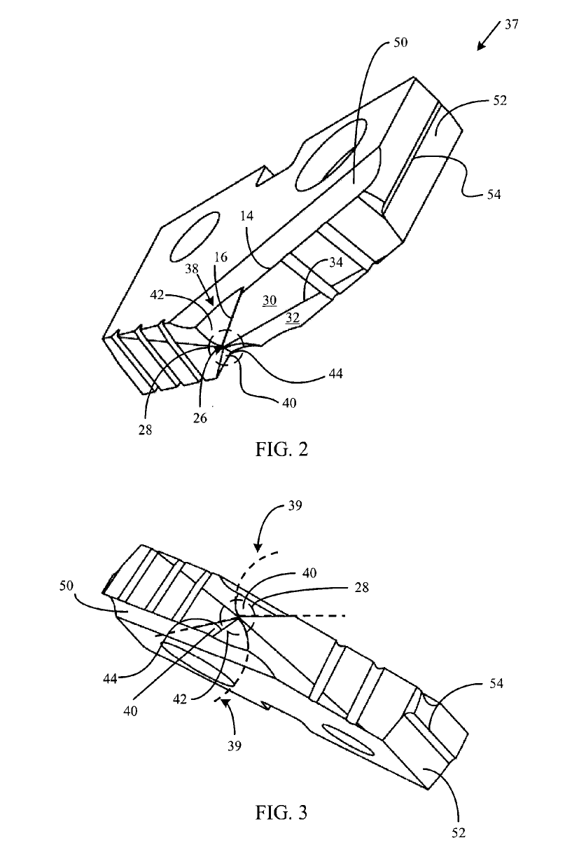

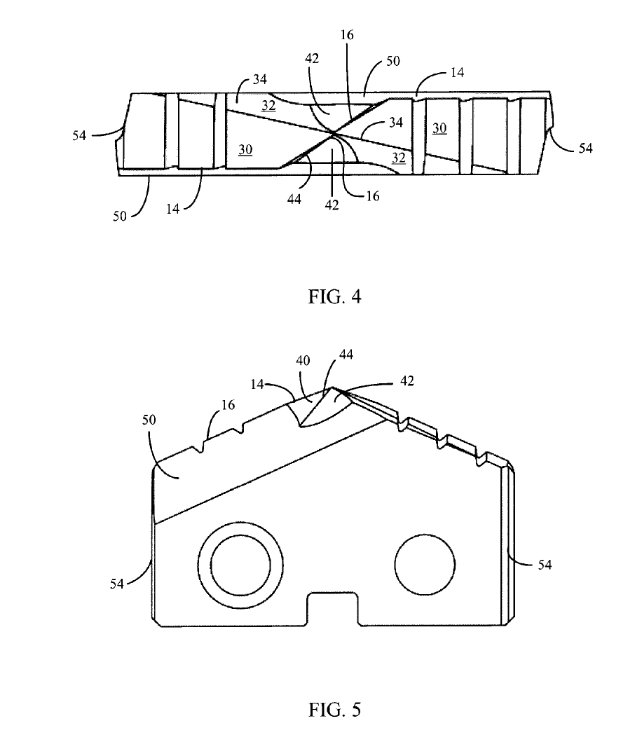

Referring to FIG. 3, the curvature of the second face 42 is configured, as shown by the arc 39, such that the material that is cut from an object by the drill insert 37 follows the curvature of the second face 42 to curl up. Accordingly, by providing a curved second face 42, the material that is cut from an object with the inner cutting edge 16 does not break or fall apart, but smoothly curls by following the curvature of the second face 42. The curvature of the valley 44 is also configured to provide a smooth transition for the cut material while moving from the first face 40 to the curved second face 42 so that the material does not break apart. Additionally, the notch 38 is configured to be wide so as to provide the above-described smooth curling up of the cut material.

The radius of the valley 44 also prevents premature splitting of the chisel 26 due to stress concentration at the chisel 26 when the drill insert 37 is operating. Because the inner cutting edge 16 forms a side of the notch 38, the inner cutting edge 16 includes a constant positive rake angle. The positive rake angle provides self centering of the chisel 26 and increases the stability of the drill insert 37 when cutting into a material. The curved surfaces of the valley 44 and the second face 42 prevent abrupt and concentrated forces to be placed on the cut material. Accordingly, the cut material curls up without breaking apart. Additionally, the cutting forces are lowered and the stability of the drill is increased.

The drill insert 37 may also include the upper curved portion 50 that is adjacent the cutting portion 13 so that the material that is cut with the outer cutting edge 14 curls along the upper curved portion 50. The drill insert 37 also includes two side walls 52 that each include a side cutting edge 54 to provide cutting of the inner walls of an aperture that is being cut by the drill insert 37. To mount the drill insert 37 into an insert holder (not shown), the drill insert 37 includes a pair of mounting apertures 56 that are sized differently so that the drill insert 37 can be properly mounted in a correct orientation into the holder. The outer curved portion 50 extends along the outer cutting edge 14 and along the notch 38. Accordingly, the material that curls and traverses the second curved face 42 will maintain its curled configuration and traverse along the outer curved portion 50 to then exit to the sides of the drill insert 37.

Furthermore, while the particular preferred embodiments have been shown and described, it will be obvious to those skilled in the art that changes and modifications may be made without departing from the teaching of the disclosure. The matter set forth in the foregoing description and accompanying drawings is offered by way of illustration only and not as limitation. The actual scope of the disclosure is intended to be defined in the following claims when viewed in their proper perspective based on the related art.

What is claimed is:

1. A drill insert comprising:
a pair of cutting webs inclined relative to each other;
a pair of transversely opposed cutting portions, each cutting portion partially defining a side portion of a corresponding cutting web, each cutting portion comprising:
an outer cutting edge;
an inner cutting edge connected to the outer cutting edge and having a positive rake angle; and
a notch having a first face, a curved second face and a curved valley, the curved valley connecting the first face and the second face, the first face bound by the curved valley and the inner cutting edge; and
a chisel defined by the first face, the valley, the second face and the inner cutting edge of each cutting portion and the cutting webs converging to a point region.

2. The drill insert of claim 1, wherein the each cutting web comprises a pair of inclined surfaces converging to the point region.

3. The drill insert of claim 1, wherein the first face is planar to define the inner cutting edge as a straight cutting edge.

4. A chisel portion for a drill insert comprising:
a centrally disposed point region;
a pair of inner cutting edges having positive rake angles and transversely opposed to each other relative to the point region;
a first notch and a second notch transversely opposed to each other relative to the point region, each of the first notch and the second notch comprising a first face, a curved second face and a curved valley, the curved valley connecting the first face and the second face, and the first face bound by the curved valley and the corresponding inner cutting edge; and
wherein the first face, the valley, the second face and the inner cutting edge of each first notch and the second notch converge to the point region.

5. The chisel portion of claim 4, further comprising a first cutting web and a second cutting web opposed to each other relative to the point region, wherein the first cutting web and the second cutting web converge to the point region.

6. The chisel portion of claim 5, wherein each cutting web comprises a pair of inclined surfaces converging to the point region.

7. The chisel portion of claim 4, wherein the first face is planar to define the inner cutting edge as a straight cutting edge.

8. A chisel portion for a drill insert comprising:
a centrally disposed point region;
a pair of inner cutting edges transversely opposed relative to the point region;
a first notch and a second notch transversely opposed relative to the point region, each of the first notch and the second notch comprising:
a first face partially defined by the corresponding inner cutting edge and configured to provide a constant positive rake angle for the inner cutting edge;
a second face having a curvature configured to provide curling of material cut from an object by the corresponding inner cutting edge; and
a valley connecting the first face and the second face, the valley having a curvature configured to control stress concentration at the point region; and
wherein the first face, the valley, the second face and the inner cutting edge of each first notch and the second notch converge to the point region.

9. The chisel portion of claim 8, further comprising a first cutting web and a second cutting web opposed to each other relative to the point region, wherein the first cutting web and the second cutting web converge to the point region.

10. The chisel portion of claim 10, wherein each cutting web comprises a pair of inclined surfaces converging to the point region.

11. The chisel portion of claim 8, wherein the first face is planar to define the inner cutting edge as a straight cutting edge.
